(19) United States
(12) Patent Application Publication
(10) Pub. No.: US 2022/0174857 A1
(43) Pub. Date: Jun. 9, 2022

(54) A MANUFACTURED SEED POD, A COMPOSITION FOR A MANUFACTURED SEED POD AND A METHOD FOR MANUFACTURING A SEED POD

(71) Applicant: AIRSEED TECHNOLOGIES HOLDINGS PTY LTD, Botany, New South Wales (AU)

(72) Inventors: Andrew Francis WALKER, Mascot, New South Wales (AU); Andries Willen LOUW, Mascot, (AU)

(21) Appl. No.: 17/594,668

(22) PCT Filed: Apr. 27, 2020
(86) PCT No.: PCT/AU2020/050401

§ 371 Date: Oct. 25, 2021

(30) Foreign Application Priority Data
Apr. 26, 2019 (AU) 2019901422

(51) Int. Cl. A01C 1/04; A01C 21/00; A01G 24/44; A01G 9/029; C05G 5/40; C05G 5/35; C05F 11/02; C05F 9/04

(52) U.S. Cl. CPC A01C 1/04; A01C 21/00; A01G 24/44; A01G 9/0291; C05F 9/04; C05G 5/40; C05G 5/35; C05F 11/02; A01G 9/0293

(57) ABSTRACT

In one embodiment, the present invention provides a degradable seed pod arranged to be delivered from a vehicle to a ground surface, the pod comprising a seed encased in a hardened material, the hardened material being composed and manufactured in a manner that shields the seed from damage when the pod experiences an impact force.

### PRIORITY

This patent application is a national phase filing under section 371 of PCT/AU2020/050401, filed on Apr. 27, 2020, which claims the priority of Australian patent application 2019901422, filed on Apr. 26, 2019, each of which is hereby incorporated by reference in its entirety.

### TECHNICAL FIELD

The present technology relates to a manufactured seed pod. In one embodiment, the invention relates to a composition for a manufactured seed pod and a method for manufacturing a seed pod.

### BACKGROUND

In recent years, there has been a growing interest in utilizing drones to assist in the reforestation of land by using the drones as a mechanism for delivering seeds across a large area of land.

Using drones as a delivery method for seed planting could plant an estimated 1 billion trees a year, saving time and labor by removing the need for people to plant seeds and/or trees by hand. In other words, using drones could make reforestation quicker and cheaper.

However, using drones, while being more efficient in terms of number of plantings per hour or day, also has disadvantages, in that many seeds may be wasted and may not be given the opportunity to germinate and grow, for a variety of reasons—from damage sustained from the seed falling on hard ground, to animals eating seeds before they can take hold in the ground.

There have been attempts to ameliorate the inherent problems created by merely “dropping” seeds in a largely random fashion, by developing mapping strategies, which may include gathering terrain data and information on the local fauna, to thereby determine a restoration potential for a particular area of land.

Once the restoration potential is determined, decisions can be made about whether it is likely that seeds dropped will germinate and take hold. However, mapping does not inherently change the potential for seeds to be eaten by animals, nor does it assist in assisting restoration in poor or difficult terrain (e.g. hard compacted earth, rocky areas, etc.).

One way of potentially reducing the possibility of animals eating seeds or assisting restoration in poor or difficult terrain is to ensure the seed is at least partially buried into the ground. In turn, one way of “burying” seeds is to “fire” rather than drop seeds by attaching a firing mechanism to the drone (e.g. a compressed air gun-type mechanism). An associated way to increase the chance of success is to fire germinated seed pellets instead of seeds, as germinated seeds have a higher chance of survival. The use of firing mechanisms, germinated seed pellets, etc., introduces further technical challenges, as germinated seeds must be handled in specific ways to ensure they continue to germinate after being fired at the ground.

Drone-powered reforestation is a viable and efficient solution to deforestation. However, in order for drone-powered reforestation to work reliably and provide better long term results than simple manual planting, there are technical challenges to be overcome in developing a system that is efficient and effective.

It is with the known prior art in mind that the present invention has been created.

### SUMMARY OF THE TECHNOLOGY

In a first aspect, there is provided a degradable seed pod arranged to be delivered from a vehicle to a ground surface, the pod comprising a seed encased in a hardened material, the hardened material being composed and manufactured in a manner that shields the seed from damage when the pod experiences an impact force.

In one embodiment, the hardened material includes one of a clay and compost mixture and a carbon mixture.

In one embodiment, the hardened material includes at least one of a seed activator, a seed fertilizer and a pesticide.

In one embodiment, the clay and compost material are mixed in a ratio of 2:3.

In one embodiment, the seed pod includes a plurality of seeds of the same plant variety.

In one embodiment, the seed pod includes a plurality of seeds of different plant varieties.

In one embodiment, there is provided an outer shell encasing the hardened material.

In one embodiment, the outer shell includes at least one of gelatin and corn flour.

In one embodiment, the seed pod is approximately spherical in shape.

In a second aspect, there is provided a method of manufacturing a seed pod, comprising the steps of mixing a clay and compost mixture, placing the mixture in a mould arranged to produce a pod, inserting a seed, moulding the resultant mixture and seed and drying the resultant moulded pod.

In one embodiment, the method comprises the further step of grinding the compost to produce a compost mixture having a fine grain size.

In one embodiment, the method comprises the further step of grinding the clay to produce a clay mixture having a fine grain size.

In one embodiment, the method comprises the further step of mixing the compost and clay in a ratio of 2:3.

In one embodiment, the method comprises the further step of adding water to the compost and clay mixture to create a putty-like consistency.

In one embodiment, the method comprises the further step of adding, to the compost and clay mixture, at least one of a seed activator, a fertilizer and a pesticide.

In one embodiment, the method comprises the further step of adding a plurality of seeds of the same plant variety to the mixture.

In one embodiment, the method comprises the further step of adding a plurality of seeds of different plant varieties to the mixture.

In one embodiment, the mould is substantially spherical in shape.

In one embodiment, the method comprises the further step of encasing the seed pod in outer shell.

In one embodiment, the manufactured seed pod is approximately 17.4 mm in diameter.

### DETAILED DESCRIPTION OF EMBODIMENTS

In the following detailed description of the embodiment, like terms refer to like features.

There is described herein a seed pod arranged to include a seed, a casing composition, and various other ingredients which are arranged to perform specific functions. One of the primary functions of the casing composition is to provide an outer casing or “shell” which protects the seed from damage when a pod is fired and when it impacts the ground.

It will be understood that when a pod is fired from a gun-like mechanism and impacts the ground (which may also be relatively hard), a seed may be subjected to significant forces which may damage the seed and therefore prevent germination. Therefore, there is a need to encase the seed in a material that serves to cushion the impact through energy absorption. Alternatively, the pod may be manufactured in a way that introduces inherent weaknesses into the outer casing of the pod (i.e. fracture points), such that, upon impact, the pod fractures, thereby delivering force away from the seed by dissipating the impact force/energy through the act of the pod fracturing.

Returning to the ingredients of the pod, in one embodiment the main component of the pod is a mixture of clay and compost. The clay and compost mixtures are sorted, weighed, measured and sieved then put through a premixing process to achieve the correct mixture of clay and compost. As the clay and compost comprise the majority (in weight and volume) of the seed pod, the clay and compost serve a dual purpose of firstly providing a growth medium to assist with the initial growth of the seed, but also, importantly, the clay and compost provide the material which serves to absorb and/or dissipate the majority of the shock wave (kinetic energy) that travels through the pod when it hits the ground with a relatively high force. In other words, the mixture of clay and compost utilized results in a composition that is hard enough to remain intact when fired from an aerial deployment device such as a drone, and correspondingly be able to withstand the impact on reasonably firm soil. The exact penetration depth will be determined upon delivery mechanism and soil conditions.

As a corollary, the mixture of clay and compost is further designed to withstand the elements and seed predators until such time as the conditions are correct for germination, ensuring that the seed germinates only when the best chance of survival is available.

There is also provided in the seed pod mixture an activator to assist in the growth of the seed in the pod. The specific composition of the activator depends on the seed variant. The pods contain a specialized range of nutrients and activators for increased germination and seedling success rates. The nutrients and activators are activated by increased moisture content allowing for germination either by rain or irrigation. In some embodiments, the seed pods may also be composed of a mixture of clay, compost and activators arranged to retain moisture to further assist in the germination and early growth phase of the seed.

In a specific embodiment, it will also be noted that the seed pod may include more than one seed. The amount of seeds per pod is also a function of many factors, including the relative hostility of the land that the seed pod is being fired into, the relative hardiness of the plant species being planted, and the likely environmental conditions that the seed pod will experience before and during germination, and also during early stages of growth.

In the embodiment described herein, the pods are sized to allow the pod to be fired from a projectile unit mounted on a drone/aerial delivery device. The size of the pod is determined by the specific requirements of the firing/delivery device and in one embodiment, is arranged to be sized to fit a commercially available projectile unit. In addition, the seed pod may be shaped in any number of manners. While an approximately spherical seed pod may be utilized, other embodiments include a “bullet-like” shaped seed pod.

In the context of the present invention, the term “bullet” is utilized to denote a shape that is reminiscent of or similar to the shape of a bullet used in a firearm. That is, an approximately cylindrical, slightly elongate shape which tends to a point (i.e. cone shaped) at one or both ends of the cylinder. The use of a bullet-like shape provides two advantages. Firstly, aerodynamically the bullet-like shape travels more efficiently through the barrel of the gun-like delivery mechanism on the drone and secondly, the more pointed end of the seed pod, if aimed towards the ground, is more likely to penetrate into the ground and lodge into the ground, thereby partially or wholly embedding the seed in the ground, providing a higher probability of the seed remaining in location and being less accessible to opportunistic animals, such as birds.

In addition, in some instances, the bullet-like shape may better dissipate the energy transferred to the seed pod as a result of hitting the ground at a relatively high speed, thereby also serving to decrease the force imparted to the seed in the pod.

The seed pods are manufactured utilizing a specific series of steps to achieve some of the desirable characteristics described above. Broadly, there is a mixing process, a moulding process and a coating and encapsulation process which are described below.

### Mixing

Step 1: Organic compost is refined to a very fine texture organic material which approximates a grain size and consistency of natural soil. To achieve this consistency, a food grade mixer blender is utilized, followed by a sifting process which occurs multiple times. In one embodiment, the material is sifted four times (although it will be understood that a different number of sifting steps may be taken depending on the compost type and initial composition). In one embodiment, the sifting tool is a handheld sift although it will be understood that a mechanical rolling drum sift mechanism may be utilized.

Step 2: The refined organic compost is then mixed with a fine clay material to a standard ratio of 2:3 (two parts clays to three parts refined compost). It will be understood that the ratio described herein, while appropriate for the example seed pod described herein, may be varied according to the required hardness of the pod or required compost for a specific seed type.

Step 3: Using a rotational small drum mixer the clay and compost mix is mixed to a uniform particle material. In the context of the embodiment described herein, the term “uniform” is utilized to denote a mixture where all grains or particles in the mixture appear, to the naked eye, to be of approximately the same size. Similar size grains ensure that the resultant mixture will mould in a manner that provides a high level of cohesion.

Step 4: Activators, nutrients and/or pesticides are added to the dry clay and compost mix. As previously described, the relative quantity and type of activators, nutrients and/or pesticides is dependent on the terrain, the seed type and the expected environmental conditions that the seed is likely to encounter during germination and early growth.

Step 5: The resultant mixture is further mixed in a food grade dough mixer while adding water (or by hand utilizing a technique similar to the mixing of food materials). In the context of the present embodiment, the term “food grade” denotes a mixer that is adapted to mix liquids and solids together to a consistency that suspends coarse free-flowing solids into a liquid carrier, while avoiding the “clumping” of the solid particles into “lumps” within the liquid carrier. An analogous example is the mixing of flour into water, such that a “smooth” dough-like (or putty like mixture is formed).

Step 6: Water is added until the dry mix becomes a formable putty-like material, akin in consistency to a soft wet clay texture.

### Moulding

The pod may be moulded in a number of manners. There is described hereinbelow two different moulding techniques, as examples of the types of steps that are required to mould a seed pod.

In the first embodiment described below, there is provided a moulding technique which is adapted to be utilisable with a “mobile” moulding system. That is, the moulding machinery and devices are housed in a shipping container. Providing a mobile moulding machine allows for the easy manufacture of soil specific, site specific seed pods and not be restricted by the transportation of organic matter across borders (seed pods are manufactured at planting location using locally sourced soil, clay compost). Bacteria and fungi isolates are analyzed, cultivated, and inoculated into the seed pods all from within the container:

### Moulding Methodology (Mobile)

Step 1: the seed pod mix, referred to colloquially as “material” is extruded via a hydraulic cylinder and ram. The material is pushed through a die and exits the extruder in a sausage shape. The sausage shape is formed to include an open slot.

Step 2: an automatic seed positioning machine inserts the required quantity of seeds into the correct location within the sausage.

Step 3: the sausage is then passed through a roller (in one embodiment, the roller is comprised of two plates on top of each other with the air gap defined between them being of a desired “sausage” diameter) to seal the sausage closed.

Step 4: The sausage is passed through a series of rotating rollers which creates seed pods, the created seed pods being substantially spherical in shape and fractionally larger than the required finished seed pod.

Step 5: The seed pods are loaded into a large open die within a large hydraulic press. The two halves of the die are hydraulically pushed together to form a completely spherical seed pod of the required diameter. The seed pods are ejected from the die by mechanical pins or pressurized air.

Step 6: The seed pods are then placed on large trays and dried in an area open to the atmosphere (e.g. in the sun) or may be passed through a mechanical rotating drum that blows warm air over the seed pods as they pass through the drum.

In the other embodiment described herein, the moulding is performed using an injection type two-part mould (50/50). The mould forms the pods to a size of 17 mm. An additional 4 mm is added to the final pod as an outer coating or cap. The resultant seed pod is a total of 17.4 mm in size. Turning to the moulding process:

Step 1: A releasing agent is applied to both sides of the mould. In one embodiment, the releasing agent is a natural plant derived oil such as coconut or canola oil. The releasing agent may be applied as a spray.

Step 2: With the mould in an open state a heavy-duty caulking gun is utilized to fill the bottom part of the half sphere with the pre-prepared mixture.

Step 3: The access material is removed from the bottom part of the mould.

Step 4: A plant seed or seeds is inserted into the flat (non-spherical) face of the half sphere.

Step 5: The mould is closed and secured with bolts.

Step 6: Through a small filler hole on the top part of the mould further mix is injected into the top half of the sphere.

Step 7: The mould is placed in an oven and the temperature is brought to 60 degrees Celsius and the mould remains in the oven for three hours.

Step 8: The mould is removed from the oven, the bolts are loosened and the mould is opened.

Step 9: The half dry pods are removed from the mould but the pod remains brittle.

Step 10: Excess material and deformities are removed from the mould using either a hand tool or a smoothing/rounding machine such as a rotation drum.

Step 11: The pods are placed on a drying table for 24 hrs to dry and harden.

### Coating and Capsulation

Once the pods have been moulded they are coated with a protective layer or alternatively are inserted into a 17.4-mm pre-manufactured biodegradable spherical capsule.

The protective layer is formed of a biodegradable material made of natural plant or animal derived materials such as gelatin and corn flower.

### BioChar (Carbon) Seed Pods

Biochar is the by-product of biomass pyrolysis in an oxygen depleted atmosphere. It contains porous carbonaceous structure and an array of functional groups. Biochar's highly porous structure can contain amounts of extractable humic-like and fluvic-like substances. Moreover, its molecular structure shows a high degree of chemical and microbial stability.

Biochar has potential as an approach to carbon sequestration, as Biochar has the potential to help mitigate climate change. Biochar is produced by processes related to Pyrogenic Carbon Capture and Storage (PyCCS). The principle of PyCCS is that the biomass (e.g. trees) removes carbon dioxide from the atmosphere during its growth via photosynthesis.

Below is provided an alternative composition of a carbon-based seed pod which also includes an alternative form of manufacture.

### BioChar Carbon Based Seed Pod Composition

Type of carbon (Biochar)
80%+ carbonated Lignocellulosic biomass.

Form of carbon used to manufacture seed pods
Ground BioChar approximately 5 microns (80%+ pure Carbon).

Type of nutrients/activators
Carbon, minerals, beneficial microbes and micro-fungi, etc.

Other elements used within the composition
NPK (Nitrogen, Phosphorus and Potassium) and nutrients (composition varies depending on area specific requirements to restore natural balance & optimizing growth potential of placed pod).
Clay (in some embodiments) and moisture binder (mist) according to specific seed pod/placement area as required.

Percentage of elements within composition
Approximately H)-20% of the seed pod is 80%+ carbon (not including the seed) but it will be understood that this percentage is variable with each application as well as other ingredients that will vary as per the placed environment. In some embodiments, more than 50% of the seed pod may be 80%+ Carbon.
Elements that are not present and should be available in the soil naturally before/without human intervention are compensated for by the addition of additives to the seed pod.

### A Step by Step Summary of the Manufacturing Process

Step 1: Seeds are prepared for germination: e.g. seed type scarified/moisture/temperature.

Step 2: Seeds are dusted & prepared with Mycorrhiza prior to being placed in a mixer (rotating drum).

Step 3: Seeds are put through a variable speed driven rotating drum.

Step 4: Seeds are rolled to build up multiple layers (“snow pod” effect); ingredients are added as per specific requirement to construct hard smooth seed pods (to ensure structural integrity) as well as optimizing growth potential needs.

### Example Manufacturing Process and Seed Pod Composition

Below there is provided an example of a seed pod manufacturing process, which is utilized to illustrate the general process steps and materials utilized to construct the seed pod. It will be understood that the example below is intended to be illustrative of the general process and applies to the embodiment described but individual ingredients, materials, quantities or method steps should not be taken as limiting on the broad inventive concept or the claimed invention, unless such features are explicitly defined in the claimed invention. That is, a person skilled in the art will understand that the seed pod may be manufactured using equivalent ingredients and materials or the seed pod may be manufactured using equivalent method steps without departing from the broad inventive concept and no ‘gloss’ should be taken from the embodiments described herein to limit the claimed invention.

Turning to the manufacturing process, firstly the seed is scarified by use of an abrasive file (water, heat cold, boiling and/or acid can also be used to create scarification—many techniques are known and a person skilled in the art will understand that any suitable technique may be utilized, taking into account seed type). Scarification weakens the outer coating of the seed and encourages germination.

Subsequently, a number of layers of ingredients/mixtures/compositions are applied to the scarified seed, as described below. It will be understood that the example below is a specific example based on a specific seed type. Variations and modifications are contemplated.

Layer 1 (2.5%)=Site specific Mycorrhizal fungi (identified from the soil samples at the planting site) is applied to the scarified seed in a powder form (dusting).

Layer 2 (5-10%)=Inoculated BioChar compromised of +80% pure carbon (carbonated Lignocellulosic biomass) is applied.

10% water is added to the mixture.

Layer 3 (40-60%) Zeolite and/or Compost, compost/soil, compost/soil/sand mix is applied to the mix in powder from.

Layer 4 (5-10%)=Inoculated BioChar compromised of +80% pure carbon (carbonated Lignocellulosic biomass) is applied.

10% water is added to the mixture.

Layer 5 (10-20%)=Bentonite is applied to the mix in powder form (acts as an external seal).

An external coating comprising a mixture of gelatin and corn starch is added as an optional extra.

Negative selection is applied utilizing a sieve selector or go/no-go gauging to fit within required tolerances (one method utilized is a secondary rotating drum with holes in the outface that the correct sized Seed pods fall through).

Drying and packing of the finished product occurs in a non-germinating & structural integrity protective environment. This is achieved through use of a hot drying process such as by using a rotating drum that has holes in the outer surface of the drum to allow hot air to be blown through the holes and into the drum.

Provided below are summaries of three different seed pods and a corresponding summary of the manufacturing process. It will be understood that the seed pods and manufacturing processes are provided by way of example only and it will be further understood that small variations for different seed types and different environments are within the purview of a person skilled in the art.

### Example Pod 1

### Tree Seed Type

Eucalyptus saligna

### Pod Size

### 17.4 mm Spherical

### Weight

<8 grams
Pod Compositions in terms of percentage mass
1. The seed is scarified by use of an abrasive file (or alternatively the seed may be heated or treated with acid, hot water or any other known and acceptable scarification methodology or technique). Scarification weakens the outer coating of the seed and encourages germination.
2. Layer 1 (2.5%)=Site specific Mycorrhizal fungi (identified from the soil samples at the planting site) is applied to the scarified seed in a powder form (dusting).
3. Layer 2 (5-10%)=Inoculated BioChar compromised of +80% pure carbon (carbonated Lignocellulosic biomass) is applied.
4. 10% water applied in a mist form is applied to the mixture.
5. Layer 3 (40-60° A_{Q})=Compost, compost/soil, compost/soil/sand mix is applied to the mix in powder form.
6. Layer 4 (5-10%)=Inoculated BioChar compromised of +80% pure carbon (carbonated Lignocellulosic biomass) is layered.
7. 10% water is applied in mist form applied to the mixture.
8. Layer 5 (5-10%)=Bentonite clay is applied to the mix in powder form (which acts as an external seal).

### Example Pod 2

### Seed Types

### Clover and Sun Hemp Seeds

Seed size
2-4 mm

### Pod Size

### 17.4 mm Spherical

### Pod Weight

<6 grams

Pod Compositions in terms of percentage mass

1. The seed is scarified by use of an abrasive file (or alternatively the seed may be heated or treated with acid, hot water or any other known and acceptable scarification methodology or technique). Scarification weakens the outer coating of the seed and encourages germination.
2. Organic Compost (55%) Organic matter that has been decomposed in a process called composting is applied.
3. Bentonite Clay (30%)=Bentonite (an absorbent aluminium phyllosilicate day consisting mostly of montmorillonite) is applied.
4. Azomite Minerals (5%)=Azomite (a composition containing over 70 minerals and trace elements, in the form of a natural mineral powder that is useful as a soil balancer and organic fertilizer) is applied.
5. NPK (5%)=Nitrogen (N), Phosphorus (P) and Potassium (K) (10-10-10 meaning equal percentages of NPK in powder form) is applied.
6. Water is applied to act as a moisture binder (applied in mist form according to manufacturing specifications).

### Example Pod 3

### Seed Types

### Clover and Sun Hemp Seeds

Seed size
2-4 mm

### Pod Size

### 17.4 mm Spherical

### Pod Weight

<6 grams
Pod Compositions in terms of percentage mass
1. The seed is scarified by use of an abrasive file (or alternatively the seed may be heated or treated with acid, hot water or any other known and acceptable scarification methodology or technique). Scarification weakens the outer coating of the seed and encourages germination.
2. Organic Compost (55%) Organic matter that has been decomposed in a process called composting is applied.
3. Bentonite Clay (30%)=Bentonite (an absorbent aluminium phyllosilicate clay consisting mostly of montmorillonite) is applied
4. Azomite Minerals (5%)=Azomite (containing over 70 minerals and trace elements in the form of a natural mineral powder that is useful as a soil balancer and organic fertilizer) is applied.
5. NPK (5%)=Nitrogen (N), Phosphorus (P) and Potassium (K) (10-10-10 meaning equal percentages of N, P and Kin powder form) is applied.
6. Water is applied as a moisture binder (applied in mist form according to manufacturing specifications).
Eco System pods

In an alternative embodiment, there is provided a different type of pod which is dubbed the “Eco system pod”. The manufacture process is largely identical to the process previously described, with the principal difference being that the eco system pod includes a combination of plant seeds including grass seeds, tree seeds and a winter or summer plant species.

In this manner, many plants germinate from a single pod, such that the eco system pods operate to create an entire mini “eco system” (i.e. ensure a variety of different plants are seeded and germinate to create an eco-system of plants rather than a single plant species germinating. This type is particularly well adapted to reforestation in land parcels that are heavily affected by the removal of most or all types of plants.

### Advantages

One of the advantages of the embodiments and broader invention described herein is that the device provides a cost effective and reliable pod that has a high probability of germinating, growing and becoming a tree or plant.

Moreover, the pods, due to their composition and manufacturing technique, have a long shelf life and are resistant to degradation and rough handling.

In addition, the eco system pods allow for a richer and more suitable “eco-system” of plants to be planted in a very efficient and cost-effective manner.

A brief summary of the advantages of using carbon seed pods and the positive impact carbon can have on seed germination/growth and soil health is provided below.

Firstly, carbon seed pods enhance plant growth and by extension provide the best plant growth possible (and the best crop productivity).

Secondly, carbon seed pods improve soil quality & fertility by boosting soil nutrient availability and moisture holding capacity, reducing leaching and saving water, thereby increasing drought resistance.

As a corollary, carbon seed pods buffer against soil acidification reducing soil acidity and increasing cation exchange capacity in soils.

Thirdly, carbon seed pods create room (surface area/shelter) in soil to allow the soil to hold more organic matter thereby creating a positive habitat for increasing beneficial micro-organisms.

Fourthly, carbon seed pods save the use of fertilizers and chemicals due to increasing the holding capability of the soil.

Fifthly, carbon seed pods result in permanent sequestering of carbon in soils to provide lasting soil benefits.

Lastly, the use of carbon contributes to the structural integrity of the carbon seed pods.

### DEFINITION AND CLARIFICATION OF TERMS AND INTENT

Throughout this specification, unless the context requires otherwise, the word “comprise” or variations such as “comprises” or “comprising”, will be understood to imply the inclusion of a stated integer or group of integers but not the explicit exclusion of any other integer or group of integers.

Those skilled in the art will appreciate that the embodiments described herein are susceptible to obvious variations and modifications other than those specifically described and it is intended that the broadest claims cover all such variations and modifications. Those skilled in the art will also understand that the inventive concept that underpins the broadest claims may include any number of the steps, features, and concepts referred to or indicated in the specification, either individually or collectively, and any and all combinations of any two or more of the steps or features may constitute an invention.

Where definitions for selected terms used herein are found within the detailed description of the invention, it is intended that such definitions apply to the claimed invention. However, if not explicitly defined, all scientific and technical terms used herein have the same meaning as commonly understood to one of ordinary skill in the art to which the invention belongs.

1. A degradable seed pod arranged to be delivered from a vehicle to a ground surface, the pod comprising a seed encased in a hardened material, the hardened material being composed and manufactured in a manner that shields the seed from damage when the pod experiences an impact force.

2. The degradable pod in accordance with claim 1, wherein the hardened material includes one of a clay and compost mixture and a carbon mixture.

3. The degradable pod in accordance with claim 2, wherein the hardened material includes at least one of a seed activator, a seed fertilizer and a pesticide.

4. The degradable pod in accordance with claim 2, wherein the clay and compost are mixed in a ratio of 2:3.

5. The degradable pod in accordance with claim 1, wherein the seed pod includes a plurality of seeds of the same plant variety.

6. The degradable pod in accordance with claim 1, wherein the seed pod includes a plurality of seeds of different plant varieties.

7. The degradable seed pod in accordance with claim 1, further including an outer shell encasing the hardened material.

8. The degradable seed pod in accordance with claim 7, wherein the outer shell includes at least one of gelatin and corn flour.

9. The degradable seed pod in accordance with claim 1, wherein the seed pod is approximately spherical in shape.

10. A method of manufacturing a seed pod, comprising the steps of mixing a clay and compost mixture, placing the mixture in a mould arranged to produce a pod, inserting a seed, moulding the resultant mixture and seed and drying the resultant moulded pod.

11. The method in accordance with claim 10, comprising the further step of grinding the compost to produce a compost mixture having a fine grain size.

12. The method in accordance with claim 11, comprising the further step of grinding the clay to produce a clay mixture having a fine grain size.

13. The method in accordance with claim 10, comprising the further step of mixing the compost and clay in a ratio of 2:3.

14. The method in accordance with any claim 10, comprising the further step of adding water to the compost and clay mixture to create a putty-like consistency.

15. The method in accordance with any claim 10, comprising the further step of adding, to the compost and clay mixture, at least one of a seed activator, a fertilizer and a pesticide.

16. The method in accordance with claim 10, comprising the further step of adding a plurality of seeds of the same plant variety to the mixture.

17. The method in accordance with claim 10, comprising the further step of adding a plurality of seeds of different plant varieties to the mixture.

18. The method in accordance with claim 10, wherein the mould is substantially spherical in shape.

19. The method in accordance with claim 10, comprising the further step of encasing the seed pod in outer shell.

20. The method in accordance with claim 10, wherein the manufactured seed pod is approximately 17.4 mm in diameter.
